(19) United States
(12) Patent Application Publication
(10) Pub. No.: US 2002/0064190 A1
(43) Pub. Date: May 30, 2002

(54) Method for compressing packet headers within a trunking protocol for aggregating multiple information channels across a network

(76) Inventors: John J. Sikora, Lincroft, NJ (US); Manuel Filipe Costa, Manalapan, NJ (US)

Correspondence Address: FISH & NEAVE, 1251 AVENUE OF THE AMERICAS, 50TH FLOOR, NEW YORK, NY, 10020-1105, US

(21) Appl. No.: 09/727,831

(22) Filed: Nov. 30, 2000

(51) Int. Cl. H04J 3/02

(52) U.S. Cl. 370/537; 370/477

(57) ABSTRACT

A method for reducing the overhead incurred by the packet headers of a trunking protocol for aggregating multiple information channels across a network is provided. The method for compressing the packet headers of the trunking protocol is applied only to the inner headers of the packets, without requiring any hardware or software modifications or configuration changes to the network equipment infrastructure. The inner header compression reduces header overhead and improves the bandwidth efficiency of the information channels.

### FIELD OF THE INVENTION

This invention relates generally to methods for compressing the packet headers of a trunking protocol. More specifically, the present invention provides a method for reducing the overhead incurred by the packet headers of a trunking protocol for aggregating multiple information channels across a network.

### BACKGROUND OF THE INVENTION

The popularity of the Internet has grown rapidly over the past several years. A decade ago, the Internet was limited to the academic and research community. Today, the Internet has grown into a communication network that reaches millions of people around the world. It provides a powerful and versatile environment for business, education, and entertainment. Millions of people worldwide access the Internet daily for communicating, retrieving information, shopping, recreating, and exploiting various other services.

The architecture of the Internet breaks down traditional geographical barriers since a dedicated end-to-end connection is not required for communicating information between a source and a destination. Instead, Internet traffic is split up into units of information called “packets” that are routed dynamically through the network based on the most efficient route between the source and the destination at any given moment. Each of these packets includes a “header” which indicates the source from which the information originates and the destination to which it is being sent, as well as other information necessary for routing the packets through the network.

Packet headers are read by a set of shared “protocols” used in all Internet transmissions. Protocols are the set of conventions that determine how information will be exchanged, often between computers from different manufacturers and running different operating systems. Internet protocols specify how the network moves data, handles errors, and allows information to be sent, received, and understood by users of different kinds of hardware and software systems. The Internet protocols are layered according to the network layer hierarchy proposed in the OSI reference model, with each layer providing additional capabilities, but using the facilities provided by the lower layer.

The most fundamental protocol is a layer three (network layer) protocol called “Internet protocol”, or simply IP protocol, responsible for the formatting and delivery of packets across the network. Transport protocols (layer four) such as UDP, TCP, and RTP, are used on top of the IP protocol to ensure that the data in the packets is received correctly, with the TCP protocol further guaranteeing that the packets are received reliably. Additional features and capabilities are provided by special-purpose protocols that are used together with the IP and transport protocols and are designed for any one of the network layers at or above layer three.

In general, special-purpose protocols are designed for the applications layer, such as the email, telnet, ftp, and http protocols, among others. Recently, a special-purpose trunking protocol has been designed to provide additional functions and enhancements to current protocol technologies at the third layer. The trunking protocol, described in commonly owned, copending, U.S. patent application Ser. No. ______ entitled “System and Method for Aggregating Multiple Information Channels Across a Network”, filed on Nov. 17, 2000, in the names of Costa and Sikora, hereafter “NAP-001”, enables the aggregation of multiple information channels across a network, such as standard modem connections, DSL lines, T1, and T3 connections, to achieve a much higher bandwidth than the one achieved by each individual information channel. The trunking protocol provides the functions of packet encapsulation, packet fragmentation, and packet order preservation, between a premises service unit (PSU) at a user's site and a service gateway (SG) at an Internet service provider.

Both the IP protocol and transport protocols specify headers that are included in each packet sent across the network. In addition, the trunking protocol requires a header that follows the same specification used for the IP header. The trunking protocol header is included in each packet on top of the IP and transport protocol headers. The typical IP and trunking protocol headers consist of 20 bytes, while the length of transport protocol headers vary according to the specific protocol being used.

Depending on the length of the packet, the overhead incurred by the headers may be substantial, resulting in an inefficient use of bandwidth. When the IP and TCP protocols are used to transmit small packets carrying voice data, for example, the header can occupy more than one half of the entire packet. The insertion of an additional trunking protocol header in the voice packet results in even more overhead and further diminishes the advantage of aggregating multiple information channels, since the effective bandwidth is only a fraction of the maximum bandwidth that can be achieved by the aggregated channels.

The header overhead can be reduced with the use of header compression technologies proposed in the Internet specification RFC 2508. The header compression technologies typically reduce the length of an IP header from twenty bytes to two or four bytes. However, the use of header compression technologies requires knowledge of the compression algorithm by the first routing point, and may also require all routers, switches, and host computers in the network to be able to compress and decompress the header. In addition, the compression technologies may cause error propagation in the case of a lost packet due to loss of synchronization when decompressing the packet headers.

In view of the foregoing drawbacks for compressing packet headers, it would be desirable to provide a method for compressing the packet headers of a trunking protocol that is transparent to the network equipment between the service gateway at the Internet service provider and the premises service unit at the user's site.

It also would be desirable to provide a method for compressing the packet headers of a trunking protocol without having to run a compression algorithm at the end stations or in the routers of the network.

It further would be desirable to provide a method for compressing the packet headers of a trunking protocol that reduces the effects of error propagation due to the loss of a packet having a compressed header.

It still further would be desirable to provide a method for compressing the packet headers of a trunking protocol that reduces header overhead and improves the bandwidth efficiency of the information channels.

### SUMMARY OF THE INVENTION

In view of the foregoing, it is an object of the present invention to provide a method for compressing the packet headers of a trunking protocol that is transparent to the network equipment between the service gateway at the Internet service provider and the premises service unit at the user's site.

It is also an object of the present invention to provide a method for compressing the packet headers of a trunking protocol without having to run a compression algorithm at the end stations or in the routers of the network.

It is a further object of the present invention to provide a method for compressing the packet headers of a trunking protocol that reduces the effects of error propagation due to the loss of a packet having a compressed header.

It still further would be desirable to provide a method for compressing the packet headers of a trunking protocol that reduces header overhead and improves the bandwidth efficiency of the information channels.

These and other objects of the present invention are accomplished by providing a method for compressing the packet headers of a trunking protocol for aggregating multiple information channels across a network. The trunking protocol is described in the previously mentioned commonly owned, copending, U.S. patent application Ser. No. ______ (NAP-001). In a preferred embodiment, the method for compressing the packet headers of the trunking protocol applies the compression technologies proposed in the Internet specification RFC 2508 only to the inner headers, i.e., the IP and transport protocol headers, in the packet or in the first packet fragment (if the packet length is L bytes or greater, wherein L is the specified cutoff packet length for fragmenting packets).

Advantageously, the present invention enables the compression and decompression of packet headers to be performed only at the service gateway (SG) at the Internet service provider and the premises service unit (PSU) at the user's site, without requiring any hardware or software modifications or configuration changes to the network equipment infrastructure currently deployed between the SG and the PSU and to the end stations of the network.

In addition, the present invention reduces the effects of error propagation due to the loss of a packet having a compressed header.

### BRIEF DESCRIPTION OF THE DRAWINGS

The foregoing and the other objects of the present invention will be apparent upon consideration of the following detailed description, taken in conjunction with the accompanying drawings, in which like reference characters refer to like parts throughout, and in which:

FIG. 1 is a schematic view of an illustrative packet transmitted across the Internet;

FIG. 2 is a schematic view of an illustrative trunking protocol header;

FIG. 3A is a schematic view of an illustrative packet transmitted in accordance with the trunking protocol;

FIG. 3B is a schematic view of an illustrative fragmented packet transmitted in accordance with the trunking protocol;

FIG. 4A is a schematic view of an illustrative packet transmitted in accordance with the trunking protocol and having packet headers compressed in accordance with the principles of the present invention; and

FIG. 4B is a schematic view of an illustrative fragmented packet transmitted in accordance with the trunking protocol and having packet headers compressed in accordance with the principles of the present invention.

### DETAILED DESCRIPTION OF THE INVENTION

The present invention provides a method for compressing the packet headers of a trunking protocol for aggregating multiple information channels across a network. The trunking protocol is described in the previously mentioned commonly owned, copending, U.S. patent application Ser. No. ______ (NAP-001), which is incorporated by reference in its entirety herein.

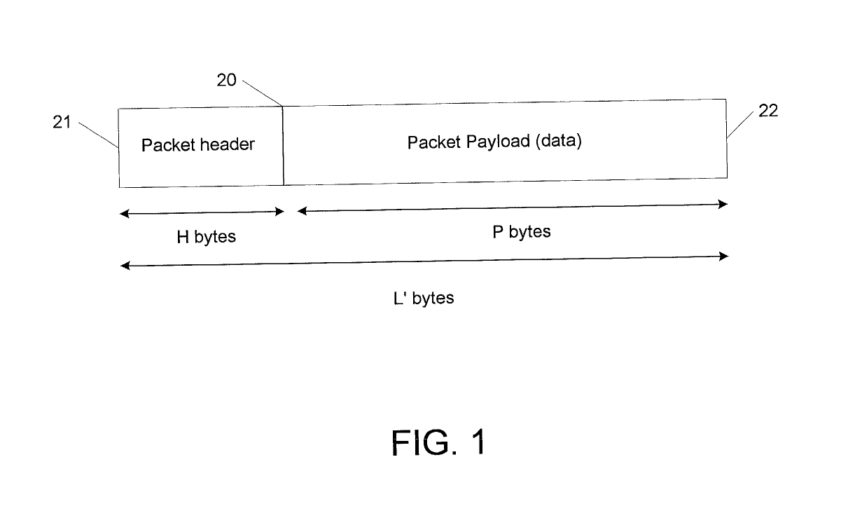

Referring to FIG. 1, a schematic view of an illustrative packet transmitted across the Internet is described. Packet 20 contains two fields: (1) packet header 21; and (2) packet payload 22. Packet header 21 consists of the Internet protocol headers used to transmit packet 20 across the Internet. At a minimum, packet header 21 contains an IP header and a transport protocol header. The IP header is required for routing the packets across the network, while the transport protocol header ensures that packet payload 22 in packet 20 is received correctly. Examples of transport protocol headers include an UDP header, a TCP header, and a combined UDP/RTP header.

Packet 20 has L′ bytes, of which H bytes are dedicated to packet header 21 and P bytes are dedicated to packet payload 22 such that the sum of H and P is equal to L′. Depending on the length L′ of packet 20, H may be smaller, equal to, or bigger than P. For packets containing IP and TCP headers, H is usually equal to forty bytes, with twenty bytes dedicated for the IP header and twenty bytes dedicated for the TCP header. The fraction H/P is typically referred to as the percentage overhead incurred by packet header 21 in packet 20.

Packet payload 22 consists of the information transmitted in the packet, including voice, data, video, and multimedia. The length P of packet payload 22 varies depending on the type of information transmitted. Voice packets are usually small, and typical voice packets consist of 64 bytes (including the header). The maximum length of packet 20 is typically 1500 bytes.

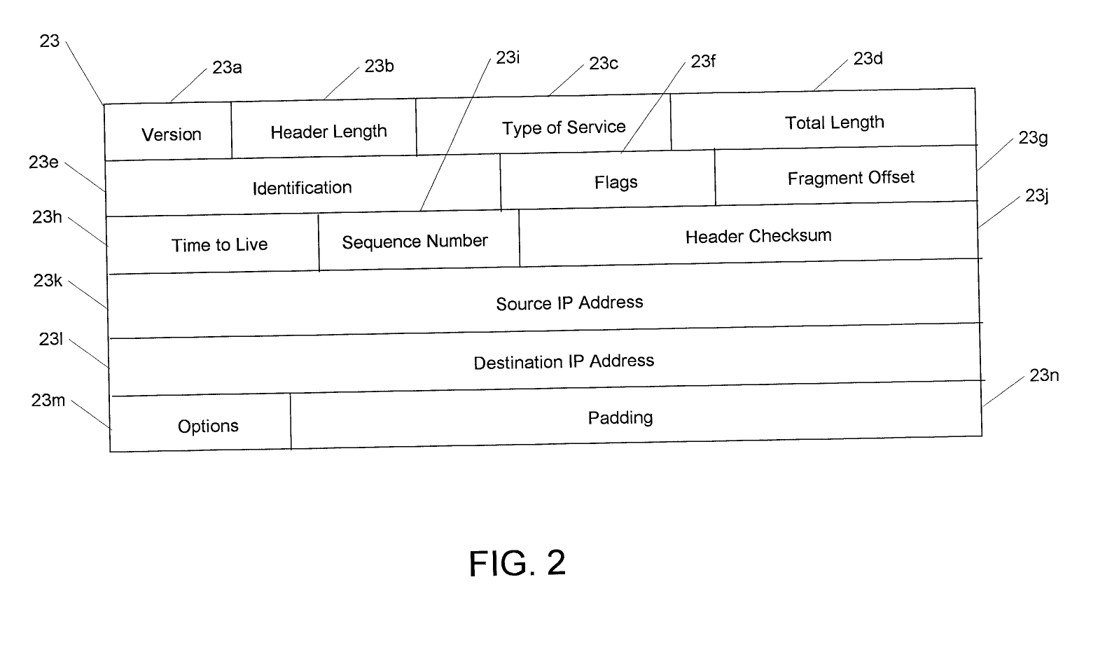

Referring now to FIG. 2, a schematic view of an illustrative trunking protocol header is described. Trunking protocol header 23 contains a variety of fields, including: (1) version 23a; (2) header length 23b; (3) type of service 23c; (4) total length 23d; (5) identification 23e; (6) flags 23f; (7) fragment offset 23g; (8) time to live 23h; (9) sequence number 23i; (10) header checksum 23j; (11) source IP address 23k; (12) destination IP address 23l; (13) options 23m; and (14) padding 23n. Source IP address 23k and destination IP address 23l enable the trunking protocol to indicate in each transmitted packet how the packet is to be distributed between an user's site and the service gateway.

Sequence number 23i is an individual identification number assigned to each packet transmitted for purposes of identifying any packets that may have been lost or delayed due to network congestion or other conditions. In case a packet is delayed, packet order preservation functions provide a buffer for the packets that are not received in sequence until the delayed packet arrives.

In addition, trunking protocol header 23 may contain options field 23m that is used for a variety of miscellaneous functions, such as configuration and enhanced quality of service (QoS) control. It will be understood by one skilled in the art that all other fields in trunking protocol header 23 may perform the same functions as the corresponding fields in a standard IP header format.

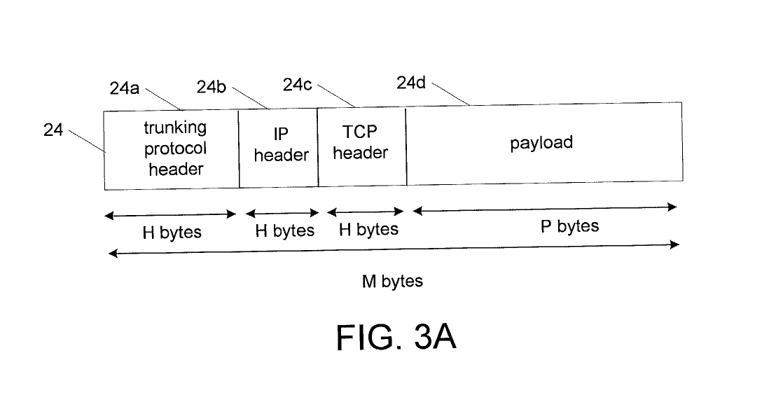

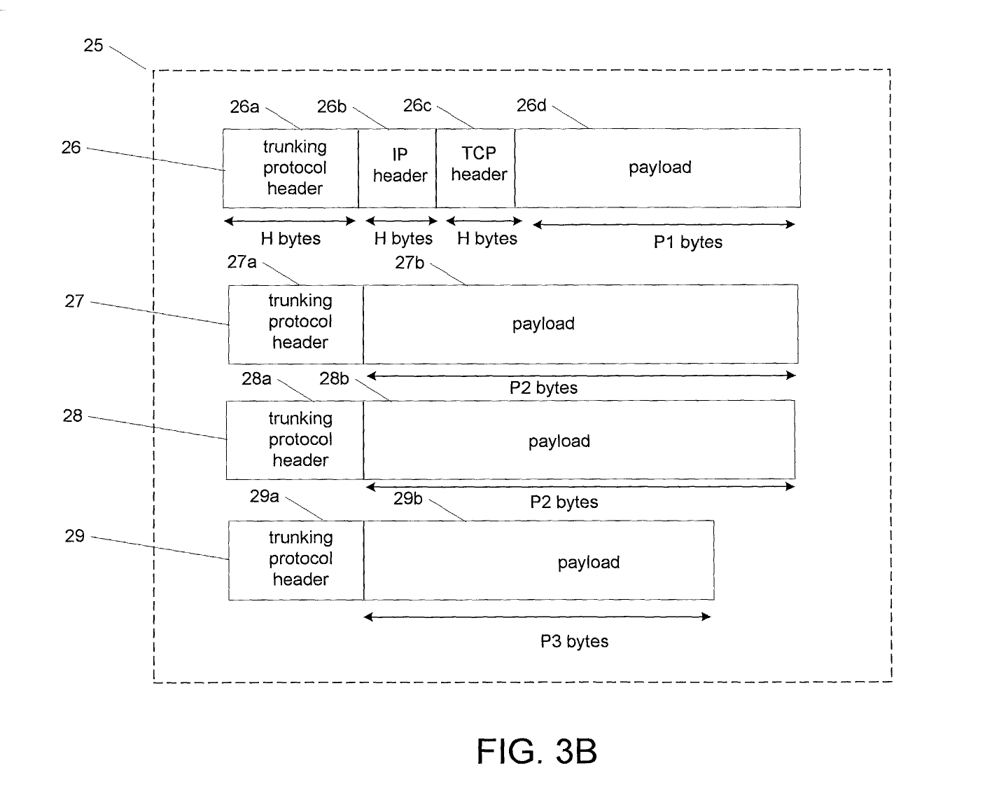

Referring now to FIG. 3A, a schematic view of an illustrative packet transmitted in accordance with the trunking protocol is described. Packet 24 is smaller than the length L specified by the trunking protocol as the cutoff length for fragmenting packets. Packet 24 contains headers 24a-c and payload 24d. Headers 24a-c are included in packet 24 according to their corresponding protocols and their relative order in the network layer hierarchy. It will be understood by one skilled in the art that header 24c may consist of other transport protocol headers, such as UDP and RDP headers. The headers in packet 24 other than trunking protocol header 24a are referred to as inner packet headers.

The first header included in packet 24 is TCP header 24c, corresponding to the TCP protocol at the fourth layer of the network layer hierarchy. TCP header 24c is followed by IP header 24b, corresponding to the IP protocol at the third layer of the network layer hierarchy. Finally, trunking protocol header 24a is included on top of IP header 24b and TCP header 24c. Trunking protocol header 24a, IP header 24b, and TCP header 24c are all of the same length, consisting of H bytes. Payload 24d consists of P bytes.

The percentage overhead incurred by headers 24a-c in packet 24 is substantial and equal to 3H/P. If packet 24 is a voice packet having a total of 24 bytes of payload and 20 bytes of header, for example, the percentage overhead in packet 24 reaches 250%, as opposed to 166% overhead without the trunking protocol. This large overhead prevents the trunking protocol from reaching the maximum bandwidth that can be achieved with the aggregation of multiple information channels. If three information channels are aggregated with each information channel providing a maximum bandwidth equal to B, for example, the maximum bandwidth that can be reached by the trunking protocol is theoretically equal to 3B. In practice, however, the effective bandwidth achieved by the trunking protocol is limited by the significant header overhead in the packet. In the voice packet example given, the effective bandwidth achieved is only 2.28B.

Referring now to FIG. 3B, a schematic view of an illustrative fragmented packet transmitted in accordance with the principles of the present invention is described. Packet 25 is larger than the length L specified by the trunking protocol as the cutoff length for fragmenting packets. As a result, the trunking protocol fragments packet 25 into packet fragments 26-29. Each packet fragment contains a payload field, with the combined payload fields 26d, 27b, 28b, and 29b forming the original payload field in packet 25 prior to fragmentation. As indicated, payload 26d consists of P1 bytes, payloads 27b and 28b consist of P2 bytes each, and payload 29b consist of P3 bytes.

Packet fragments 26-29 also contain trunking protocol headers 26a, 27a, 28a, and 29a, with each header having a sequence number to identify the sequence of the packet fragments and the packets. Packet fragment 26, being the first packet fragment of packet 25, also includes IP header 26b and TCP header 26c, in accordance with the format established by the IP and TCP/IP protocols. IP header 26b and TCP header 26c are the inner headers of packet 25. These inner headers are required in the first packet fragment for the proper network routing to be established. The IP and TCP headers do not need to be included in the subsequent packet fragments since the trunking protocol header in each packet fragment is able to provide the necessary information for routing the packets between the PSU and the SG. This capability of the trunking protocol reduces the header overhead incurred in each packet fragment. Further, it will be understood by one skilled in the art that TCP header 26c is not limited to the TCP/IP protocol but may be any other header of a layer four protocol, such as the UDP and RTP protocols.

The percentage overhead incurred by headers 26a-c in packet 25 is substantial and equal to 6H/T, where T is the total payload of packet 25 and equal to P1+P2+P3. If T is equal to 1000 bytes and H is equal to 20 bytes, for example, the percentage overhead in packet 25 is 12%, as opposed to 4% without the trunking protocol.

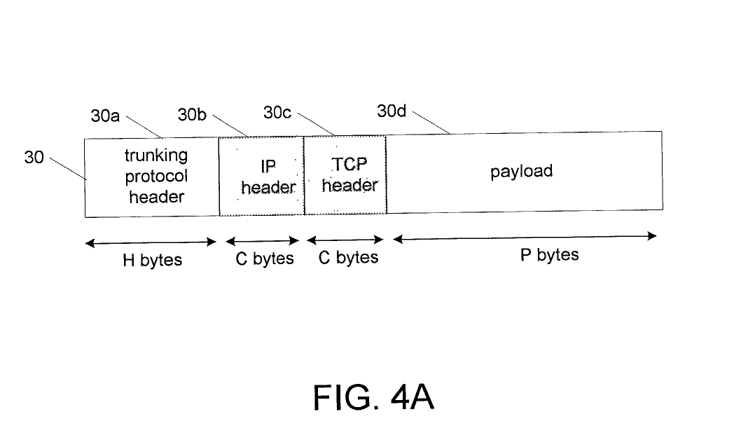

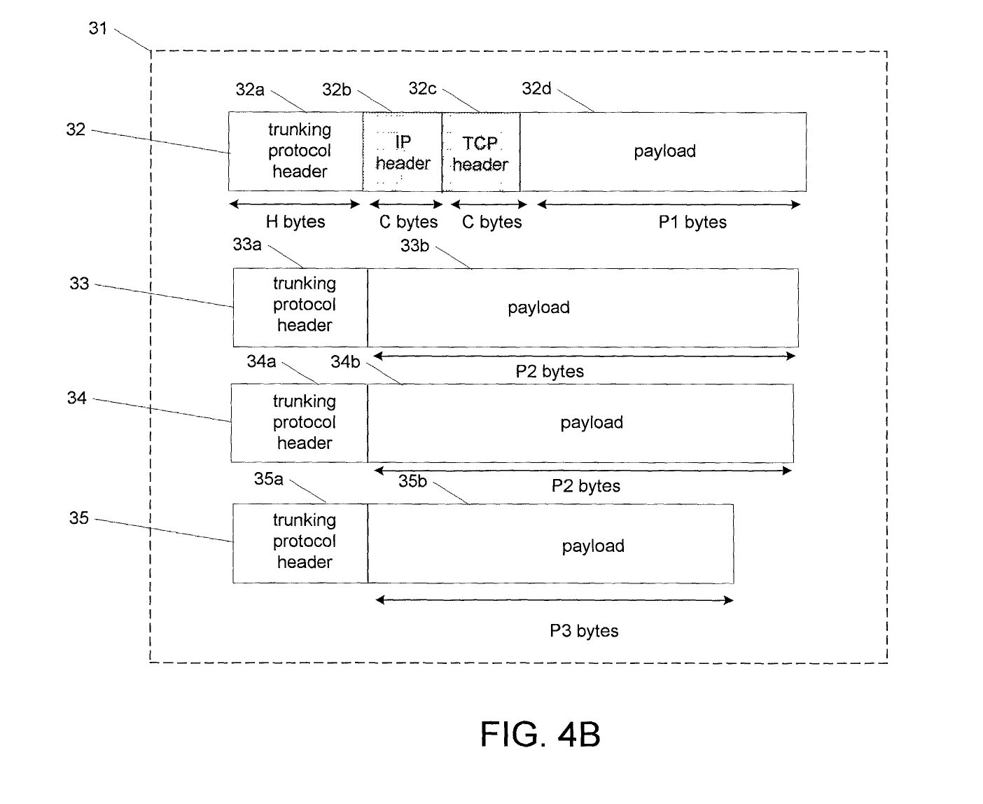

Referring now to FIG. 4A, a schematic view of an illustrative packet transmitted in accordance with the trunking protocol and having packet headers compressed in accordance with the principles of the present invention is described. Packet 30 is smaller than the length L specified by the trunking protocol as the cutoff length for fragmenting packets. Packet 30 contains headers trunking protocol header 30a, IP header 30b, TCP header 30c, and payload 30d.

To reduce the overhead incurred by headers 30a-c, header compression technologies such as the ones proposed in the Internet specification RFC 2508 are applied to IP header 30b and TCP header 30c. IP header 30b and TCP header 30c are originally H bytes, and after applying the compression technologies, they are reduced to C bytes, with C smaller than H. Typically, H is equal to twenty bytes and C is equal to two bytes. Header compression is only applied to IP header 30b and TCP header 30c so that no hardware or software modifications or configuration changes are required to the network equipment infrastructure currently deployed between the SG and the PSU and to the end stations of the network.

Comparing packet 30 to packet 24 shown in FIG. 3A, the percentage overhead is reduced from 3H/P to (2C+H)/P. For a packet payload of 24 bytes and a header of 20 bytes, this results in a reduction in overhead from 250% in case of packet 24 shown in FIG. 3A to 100% in case of packet 30, smaller than the 166% overhead without the trunking protocol. This dramatic improvement enables the trunking protocol to take full advantage of the aggregation of multiple information channels, since the effective bandwidth is now able to approximately reach the maximum bandwidth that can be achieved by the aggregated channels. If three information channels are aggregated with each information channel providing a maximum bandwidth equal to B, for example, the header compression technologies now enable the trunking protocol to achieve an effective bandwidth approximately equal to 3B.

Further, to reduce the effects of error propagation due to the loss of a packet having a compressed header, the header compression technologies are not applied to one packet out of a given number of packets that has been transmitted.

It should be understood by one skilled in the art that any header compression technology can be applied to reduce the overhead incurred by the IP and TCP headers.

Referring now to FIG. 4B, a schematic view of an illustrative fragmented packet transmitted in accordance with the trunking protocol and having packet headers compressed in accordance with the principles of the present invention is described. Packet 31 is larger than the length L specified by the trunking protocol as the cutoff length for fragmenting packets. As a result, the trunking protocol fragments packet 31 into packet fragments 32-35. Each packet fragment contains a payload field, with the combined payload fields 32d, 33b, 34b, and 35b forming the original payload field in packet 31 prior to fragmentation. Packet fragments 32-35 also contain trunking protocol headers 32a, 33a, 34a, and 35a. In addition, packet fragment 32, being the first packet fragment of packet 31, also includes IP header 32a and TCP header 32b.

To reduce the overhead incurred by headers 32a-c, 33a, 34a, and 35a, header compression technologies are applied to IP header 32b and TCP header 32c so that the lengths of IP header 32b and TCP header 32c are significantly reduced. IP header 32b and TCP header 32c are originally H bytes, and after applying the compression technologies, they are reduced to C bytes, with C smaller than H. Typically, H is equal to twenty bytes and C is equal to two bytes. Header compression is only applied to IP header 32b and TCP header 32c so that no hardware or software modifications are required to the network equipment infrastructure currently deployed between the SG and the PSU and to the end stations of the network.

Comparing packet 32 to packet 25 shown in FIG. 3B, the percentage overhead is reduced from 6H/T to (2C+4H)/P. For a packet payload of 1000 bytes, H equal to 20 bytes, and C equal to two bytes, this results in a reduction in overhead from 12% in case of packet 25 shown in FIG. 3A to 8.4% in case of packet 32, as opposed to 4% without the trunking protocol. This dramatic improvement enables the trunking protocol to take full advantage of the aggregation of multiple information channels, since the effective bandwidth is now able to more closely approximate the maximum bandwidth that can be achieved by the aggregated channels.

Although particular embodiments of the present invention have been described above in detail, it will be understood that this description is merely for purposes of illustration. Specific features of the invention are shown in some drawings and not in others, and this is for convenience only and any feature may be combined with another in accordance with the invention. Steps of the described processes may be reordered or combined, and other steps may be included. Further variations will be apparent to one skilled in the art in light of this disclosure and are intended to fall within the scope of the appended claims.

What is claimed is:

1. A method for improving the effective bandwidth of multiple information channels across a network, the multiple information channels being aggregated by a trunking protocol, the method comprising:
generating packets having a trunking protocol header, inner packet headers, and a payload;
applying header compression to the inner packet headers of the packets;
transmitting the packets between a service gateway and a premises service unit;
applying header decompression to the compressed inner headers of the packets.

2. The method of claim 1, wherein the information channels comprise standard modem connections.

3. The method of claim 1, wherein the information channels comprise DSL lines.

4. The method of claim 1, wherein the information channels comprise T1 lines.

5. The method of claim 1, wherein the information channels comprise T3 lines.

6. The method of claim 1, wherein the information channels comprise layer one and layer two technologies.

7. The method of claim 1, wherein the information channels comprise a combination of two or more of standard modem connections, DSL lines, T1 lines, T3 lines, and other layer one and layer two technologies.

8. The method of claim 1, wherein applying header compression to the inner packet headers comprise applying the RFC 2508 header compression algorithms to the inner packet headers.

9. The method of claim 1, wherein applying header decompression to the inner packet headers comprise applying the RFC 2508 header decompression algorithms to the inner packet headers.

10. The method of claim 1, wherein the inner packet headers comprise a IP header and a TCP header.

11. The method of claim 1, wherein the inner packet headers comprise a IP header and a UDP header.

12. The method of claim 1, wherein the inner packet headers comprise headers at layer four or higher layers.

13. The method of claim 1, wherein the inner packet headers comprise a IP header, a UDP header, a RTP header, and headers at layer four or higher layers.

14. A method for improving the effective bandwidth of multiple information channels across a network, the multiple information channels being aggregated by a trunking protocol, the method comprising:
generating packets having a trunking protocol header, inner packet headers, and a payload;
applying header compression to the inner packet headers of a plurality of the packets;
transmitting the packets between a service gateway and a premises service unit, wherein packets having uncompressed inner headers are periodically transmitted among the plurality of packets having compressed inner headers;
applying header decompression to the compressed inner headers of the plurality of packets.

15. The method of claim 14, wherein the information channels comprise standard modem connections.

16. The method of claim 14, wherein the information channels comprise DSL lines.

17. The method of claim 14, wherein the information channels comprise T1 lines.

18. The method of claim 14, wherein the information channels comprise T3 lines.

19. The method of claim 14, wherein the information channels comprise layer one and layer two technologies.

20. The method of claim 14, wherein the information channels comprise a combination of two or more of standard modem connections, DSL lines, T1 lines, T3 lines, and other layer one and layer two technologies.

21. The method of claim 14, wherein applying header compression to the inner packet headers comprise applying the RFC 2508 header compression algorithms to the inner packet headers.

22. The method of claim 14, wherein applying header decompression to the inner packet headers comprise applying the RFC 2508 header decompression algorithms to the inner packet headers.

23. The method of claim 14, wherein the inner packet headers comprise a IP header and a TCP header.

24. The method of claim 14, wherein the inner packet headers comprise a IP header and a UDP header.

25. The method of claim 14, wherein the inner packet headers comprise headers at layer four or higher layers.

26. The method of claim 14, wherein the inner packet headers comprise a IP header, a UDP header, a RTP header, and headers at layer four or higher layers.
